(19) United States
(12) Patent Application Publication
(10) Pub. No.: US 2023/0396283 A1
(43) Pub. Date: Dec. 7, 2023

(54) AIRBAG ANTI-FALLING PROTECTIVE SHELL

(71) Applicant: Qinyin HU, Shiyan (CN)

(72) Inventor: Qinyin HU, Shiyan (CN)

(21) Appl. No.: 18/451,697

(22) Filed: Aug. 17, 2023

(51) Int. Cl. H04B 1/3888

(52) U.S. Cl. CPC H04B 1/3888

(57) ABSTRACT

Disclosed is an airbag anti-falling protective shell, which comprises a frame body and a back plate; the back plate is arranged on a rear side of the frame body and forms an accommodating cavity for placing an electronic device by enclosing with the frame body; and a plurality of through grooves are formed on inner and outer side walls of the frame body in a penetrating mode, the plurality of through grooves are distributed on an outer periphery of the accommodating cavity and all communicated with the accommodating cavity, each through groove is filled, molded and fixed with an airbag body, the airbag body is made of a transparent material, an air cavity is arranged in each airbag body, and decorative particles are placed in each air cavity. Each through groove is filled, molded and fixed with the airbag body, and the airbag body contacts with the electronic device.

### TECHNICAL FIELD

The present invention relates to the technical field of protective shells, and is particularly an airbag anti-falling protective shell.

### BACKGROUND OF THE PRESENT INVENTION

A protective shell is a decoration for protecting or decorating appearances of electronic devices such as mobile phones and tablet computers. With the rapid development of science and technology, the industry of scientific beauty has emerged as a new industry. With the diversified development of market, fashion IT brands are diversified aiming at increased brands and functions of the electronic devices, and the protective shells of the electronic devices are divided into PC shells, leather shells, silica gel shells, cloth shells, hard plastic shells, leather sheath shells, metal tempered glass shells, soft plastic shells, velvet shells and silk shells according to textures. The protective shells of the electronic devices not only serve as the decorations to make the electronic devices of consumers become a sight, but also protect the electronic devices from falling, scratching, water ingress and shocking.

At present, a main structure of the protective shells of the electronic devices comprises a frame body and a back plate; and the back plate is arranged on a rear side of the frame body and forms an accommodating cavity for placing an electronic device by enclosing with the frame body. However, in the prior art, the frame body contacting with the electronic device is made of a solid material as a whole, which has a poor shock absorption effect, cannot achieve good buffering and anti-falling effects, and has poor decorative and beautifying effects. Therefore, it is necessary to improve current electronic devices.

### SUMMARY OF PRESENT INVENTION

In view of this, the present invention aims at the defects in the prior art, and is mainly intended to provide an airbag anti-falling protective shell, which can effectively solve the problems of poor shock absorption effect and poor decorative and beautifying effects of an existing protective shell of an electronic device.

In order to achieve the above object, the following technical solutions are used in the present invention.

An airbag anti-falling protective shell comprises a frame body and a back plate; the back plate is arranged on a rear side of the frame body and forms an accommodating cavity for placing an electronic device by enclosing with the frame body; and a plurality of through grooves are formed on inner and outer side walls of the frame body in a penetrating mode, the plurality of through grooves are distributed on an outer periphery of the accommodating cavity and all communicated with the accommodating cavity, each through groove is filled, molded and fixed with an airbag body, the airbag body is made of a transparent material, an air cavity is arranged in each airbag body, and decorative particles are placed in each air cavity.

Preferably, the frame body is made of a TPU material.

Preferably, the back plate is made of a transparent PC anti-scratching material, and the back plate and the frame body are molded and fixed together.

Preferably, a plurality of airbag bodies are integrally molded and connected in sequence.

Preferably, a plurality of key grooves are formed on the inner and outer side walls of the frame body in a penetrating mode, and a key body is arranged in each key groove.

Preferably, the back plate is provided with a window for exposing a camera.

Preferably, a sound guide groove and an interface groove are formed on inner and outer side surfaces of the frame body in a penetrating mode.

Compared with the prior art, the present invention has obvious advantages and beneficial effects, and specifically, according to the above technical solutions:
each through groove is filled, molded and fixed with the airbag body, and the airbag body contacts with the electronic device, so that a good shock absorption effect is achieved, and good buffering and anti-falling effects are achieved, and meanwhile, the airbag body is made of the transparent material, the air cavity is arranged in each airbag body, and the decorative particles are placed in each air cavity, so that the product has good decorative and beautifying effects and meets the needs of consumers.

### DESCRIPTION OF THE DRAWINGS

FIG. 1 is a stereoscopic diagram of assembly of a preferred embodiment of the present invention;

FIG. 2 is an exploded view of the preferred embodiment of the present invention; and

FIG. 3 is a sectional view of the preferred embodiment of the present invention.

### DESCRIPTION OF REFERENCE NUMERALS

10 refers to frame body 11 refers to through groove
12 refers to key groove 13 refers to sound guide groove
14 refers to interface groove 101 refers to accommodating cavity
20 refers to back plate 21 refers to window
30 refers to key body 40 refers to airbag body
41 refers to air cavity 50 refers to decorative particle

### DETAILED DESCRIPTION OF PREFERRED EMBODIMENTS

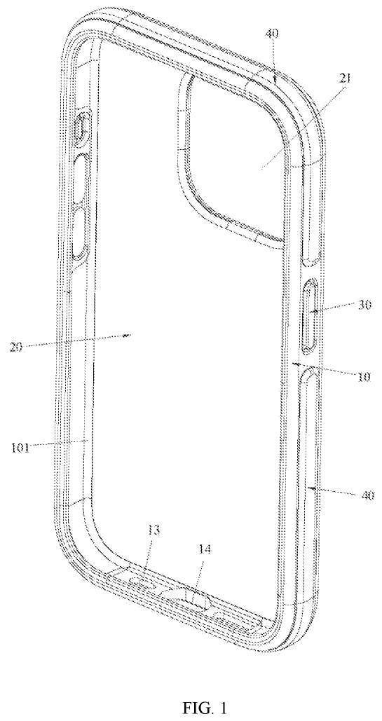

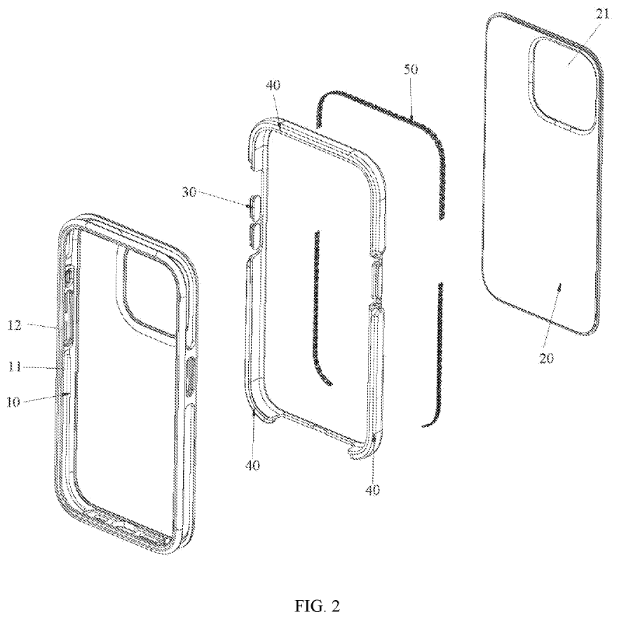

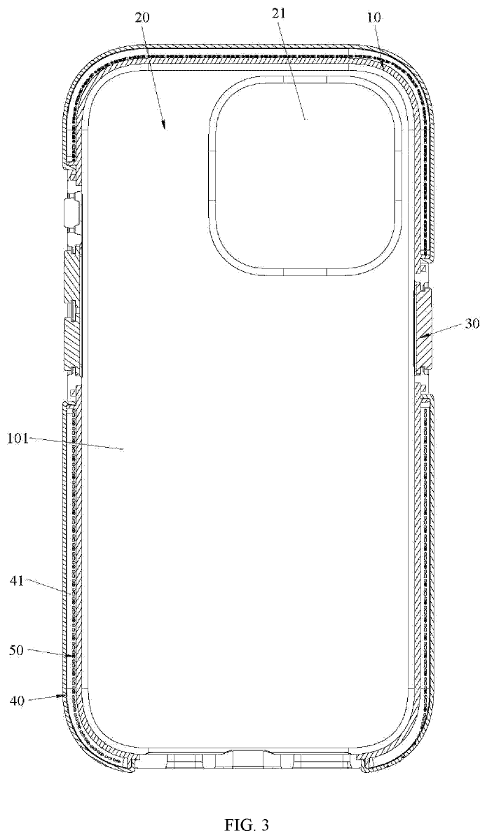

With reference to FIG. 1 to FIG. 3, a specific structure of a preferred embodiment of the present invention is shown, which comprises a frame body 10 and a back plate 20.

The frame body 10 is made of a TPU material, and a plurality of through grooves 11 are formed on inner and outer side walls of the frame body 10 in a penetrating mode. A plurality of key grooves 12 are formed on the inner and outer side walls of the frame body 10 in a penetrating mode, and a key body 30 is arranged in each key groove 12. Moreover, a sound guide groove 13 and an interface groove 14 are formed on inner and outer side surfaces of the frame body 10 in a penetrating mode.

The back plate 20 is arranged on a rear side of the frame body 10 and forms an accommodating cavity 101 for placing an electronic device by enclosing with the frame body 10. The plurality of through grooves 11 are distributed on an outer periphery of the accommodating cavity 101 and all communicated with the accommodating cavity 101, each through groove 11 is filled, molded and fixed with an airbag body 40, the airbag body 40 is made of a transparent material, an air cavity 41 is arranged in each airbag body 40, and decorative particles 50 are placed in each air cavity 41. The decorative particles 50 roll in the air cavity 41. In the embodiment, the back plate 20 is made of a transparent PC anti-scratching material, and the back plate 20 and the frame body 10 are molded and fixed together. The back plate 20 is provided with a window 21 for exposing a camera. A plurality of airbag bodies 40 are integrally molded and connected in sequence.

A use method of the embodiment is described in detail as follows.

During manufacturing, the frame body 10 is molded first, then the airbag body 40 is molded on the frame body 10, and the decorative particles 50 are placed in while the airbag body 40 is molded, and finally, the back plate 20 is molded on a back surface of the frame body 10.

When in use, the electronic device (such as a mobile phone or a tablet computer) is embedded in the accommodating cavity 101, so that a peripheral side of the electronic device contacts with an inner side surface of the airbag body 40, thus achieving a good shock absorption effect on the electronic device. Meanwhile, the decorative particles 50 roll in the air cavity 41 during use, thus achieving good decorative and beautifying effects.

Key points of design of the present invention are that: each through groove is filled, molded and fixed with the airbag body, and the airbag body contacts with the electronic device, so that a good shock absorption effect is achieved, and good buffering and anti-falling effects are achieved, and meanwhile, the airbag body is made of the transparent material, the air cavity is arranged in each airbag body, and the decorative particles are placed in each air cavity, so that the product has good decorative and beautifying effects and meets the needs of consumers.

The technical principles of the present invention are described above with reference to the specific embodiments. These descriptions are only for the purpose of explaining the principles of the present invention, and cannot be interpreted as limiting the scope of protection of the present invention in any way. Based on the explanation herein, those skilled in the art may think of other specific embodiments of the present invention without going through any creative work, which will all fall within the scope of protection of the present invention.

I claim:

1. An airbag anti-falling protective shell, comprising a frame body and a back plate; the back plate being arranged on a rear side of the frame body and forming an accommodating cavity for placing an electronic device by enclosing with the frame body, wherein a plurality of through grooves are formed on inner and outer side walls of the frame body in a penetrating mode, the plurality of through grooves are distributed on an outer periphery of the accommodating cavity and all communicated with the accommodating cavity, each through groove is filled, molded and fixed with an airbag body, the airbag body is made of a transparent material, an air cavity is arranged in each airbag body, and decorative particles are placed in each air cavity.

2. The airbag anti-falling protective shell according to claim 1, wherein the frame body is made of a TPU material.

3. The airbag anti-falling protective shell according to claim 1, wherein the back plate is made of a transparent PC anti-scratching material, and the back plate and the frame body are molded and fixed together.

4. The airbag anti-falling protective shell according to claim 1, wherein a plurality of airbag bodies are integrally molded and connected in sequence.

5. The airbag anti-falling protective shell according to claim 1, wherein a plurality of key grooves are formed on the inner and outer side walls of the frame body in a penetrating mode, and a key body is arranged in each key groove.

6. The airbag anti-falling protective shell according to claim 1, wherein the back plate is provided with a window for exposing a camera.

7. The airbag anti-falling protective shell according to claim 1, wherein a sound guide groove and an interface groove are formed on inner and outer side surfaces of the frame body in a penetrating mode.
